(19) United States
(12) Patent Application Publication
(10) Pub. No.: US 2013/0173526 A1
(43) Pub. Date: Jul. 4, 2013

(54) METHODS, SYSTEMS, AND MEANS FOR AUTOMATICALLY IDENTIFYING CONTENT TO BE PRESENTED

(71) Applicants: Ka Chun Wong, Tai Po (HK); Will Liu, San Po Kong (HK); Jianan Zheng, Kowloon (HK); Rio Kwok, Tai Wai (HK); Adrian Ng, Tseung Kwan O (HK)

(72) Inventors: Ka Chun Wong, Tai Po (HK); Will Liu, San Po Kong (HK); Jianan Zheng, Kowloon (HK); Rio Kwok, Tai Wai (HK); Adrian Ng, Tseung Kwan O (HK)

(73) Assignee: UNITED VIDEO PROPERTIES, INC., Santa Clara, CA (US)

(21) Appl. No.: 13/339,867

(22) Filed: Dec. 29, 2011

(51) Int. Cl. G06N 5/02

(52) U.S. Cl. 706/54

(57) ABSTRACT

Methods, systems, and means for automatically identifying content to he presented are provided. In particular, content may he automatically identified by first determining a duration during which a user will be performing an activity and determining a mood description of the activity. Characteristics of a plurality of the entertainment content that include length of each of the plurality of entertainment content and a mood description of each of the plurality of entertainment content may be retrieved from memory. The retrieved characteristics may then be compared with the duration of the activity and the mood description of the activity. Next, entertainment content from the plurality of entertainment content to be presented during the activity may be automatically selected. Finally, the entertainment content may be presented to the user.

### BACKGROUND OF THE INVENTION

When a person is performing various activities, it is frequently desirable to have entertainment content presented to the person. For example, when a person is exercising, the person may desire to listen to music or watch a television program.

However, selecting such content can be difficult or an annoyance to the person. For example, a person might not have any particular content in mind and might not want to be bothered with searching for and identifying particular content.

### SUMMARY OF THE INVENTION

In view of the foregoing, methods, systems, and means for automatically identifying content to he presented are provided. In particular, content may he automatically identified by first determining a duration during which a user will be performing an activity and determining a mood description of the activity. Characteristics of a plurality of the entertainment content that include length of each of the plurality of entertainment content and a mood description of each of the plurality of entertainment content may be retrieved from memory. The retrieved characteristics may then be compared with the duration of the activity and the mood description of the activity. Next, entertainment content from the plurality of entertainment content to be presented during the activity may be automatically selected. Finally, the entertainment content may be presented to the user.

In some embodiments, the duration may be determined based on input received from the user, based on previous activities performed by the user, or based on previous activities performed by the user at a certain time of day.

In some embodiments, the mood description of the activity may be determined based on input received from the user, based on previous activities performed by the user, based on previous activities performed by the user at a certain time of day, based on an environmental factor of an area around the user while performing the activity, or based on at least one of motion and biometric data of the user while performing the activity.

In some embodiments, multiple pieces of entertainment content from the plurality of entertainment content are automatically selected.

In some embodiments, information on at least two of the duration, the mood description, the entertainment content, and a description of the activity can also be sent to social media.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1, 2, and 3 show illustrative display screens that may be used to provide media guidance application listings in accordance with some embodiments of the invention;

FIG. 4 is a diagram of a process for automatically identifying and presenting content in response to a user selection of a duration and a mood description in accordance with some embodiments of the invention;

FIG. 5 shows an illustrative user interface for selecting an activity description, a duration, and a mood description in accordance with some embodiments of the invention;

FIG. 6 shows an illustration of a user interface for presenting information regarding content being presented and for enabling a user to select to have other content identified, to change an activity description, to change a duration, to change a mood description, and to share information on social media in accordance with some embodiments of the invention;

FIG. 7 is a diagram of a process for automatically identifying and presenting content based on previous activity in accordance with some embodiments of the invention;

FIG. 8 is a diagram of a process for taking actions on previous activity and on future activity in accordance with some embodiments of the invention;

FIG. 9 shows an illustrative user interface for taking actions on previous activity and on future activity in accordance with some embodiments of the invention;

FIG. 10 shows an illustrative user interface for presenting future activity in an interactive program guide in accordance with some embodiments of the invention;

FIG. 11 shows an illustrative user equipment device in accordance with some embodiments of the invention;

FIG. 12 is a diagram of an illustrative cross-platform interactive media system in accordance with some embodiments of the invention;

FIG. 13 is an illustrative of a sample XML file for recording an activity in accordance with some embodiments of the invention; and

FIG. 14 is an illustrative of a sample XML file for program listing information in accordance with some embodiments of the invention.

### DETAILED DESCRIPTION OF EMBODIMENTS

The invention generally relates to methods, systems, and means for automatically identifying content to be presented. In particular, content may be automatically identified by first determining a duration during which a user will be performing an activity and determining a mood description of the activity. Characteristics of a plurality of the entertainment content that include length of each of the plurality of entertainment content and a mood description of each of the plurality of entertainment content may be retrieved from memory. The retrieved characteristics may then be compared with the duration of the activity and the mood description of the activity. Next, entertainment content from the plurality of entertainment content to be presented during the activity may be automatically selected. Finally, the entertainment content may be presented to the user.

The amount of content available to users in any given content delivery system can be substantial. Consequently, many users desire a form of media guidance through an interface that allows users no efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e g., parental control ratings, critic's ratings, etc.), duration/length information, mood information, genre or category information, actor information, logo data for broadcasters' or providers' logos, etc.), media format (e.g., standard definition, high definition, 3D, etc.), advertisement information. (e.g., text, images, media clips, etc.), on-demand information, blogs, websites, and any other type of guidance data that is helpful for a user to navigate among and locate desired content selections.

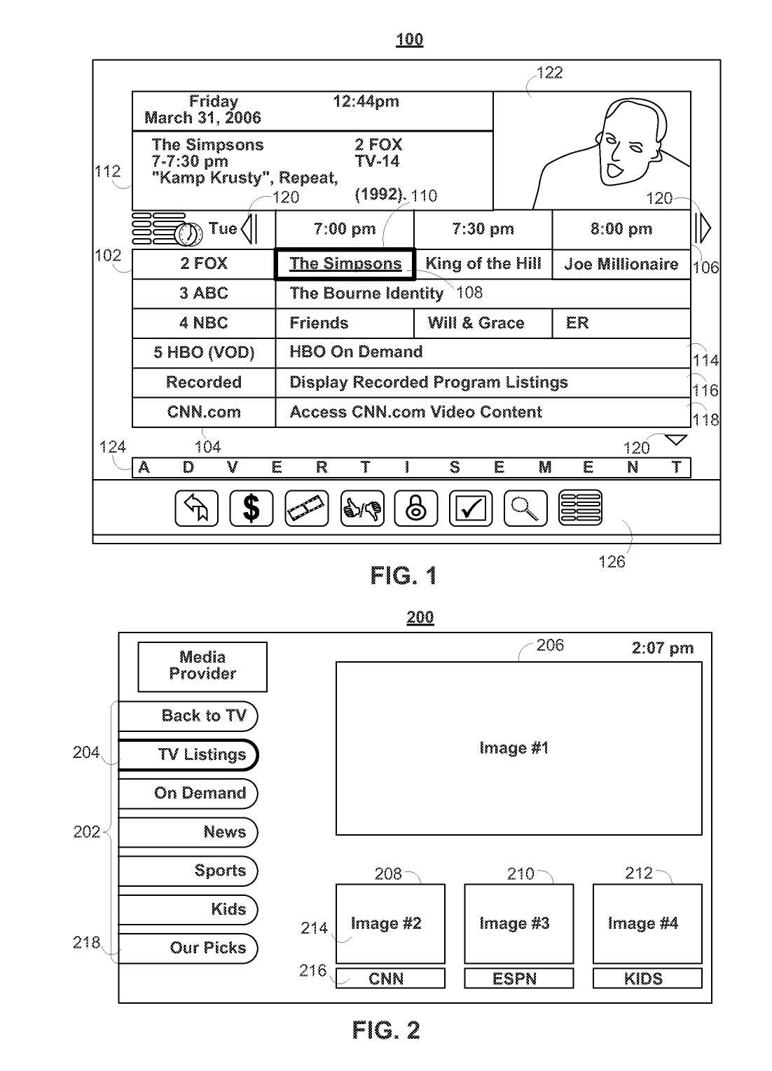

FIGS. 1-2 show illustrative display screens that may be used to provide media guidance data The display screens shown in FIGS. 1-2 and 3, 5-6, and 9-10 may be implemented on any suitable user equipment device or platform. While the displays of FIGS. 1-2 and 3, 5-6, and 9-10 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or a guidance application definition (e.g., a display of only recorded and broadcast listings, only on-demand and broadcast listings. As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available no the user. The content of video region 122 may correspond to, or be independent from, one of the listings displayed in grid 102. Grid displays including a video region are sometimes referred to as picture-in-guide (PIG) displays. PIG. displays and their functionalities are described in greater detail in Satterfield et al. U.S. Pat. No. 6,564,373, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may he provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson at al., U.S. Patent Application Publication No. 2003/0110499, filed Jan. 17, 2003; Ward., III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a use input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, an “Our Picks” option (as described below), parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences.A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 12. Additional personalized media guidance application features are described in greater detail in Ellis et al., U.S. Patent Application Publication No. 2005/0251827, filed Jul. 11, 2005, Boyer et al., U.S. Pat. No. 7,165,093, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

As shown in FIG. 2, selectable options can include an “Our Picks” option 218 to aid a user in selecting content in accordance with some embodiments. As described further below, this option may be provided to automatically present content to a user based on any suitable criteria or criterion. For example, in some embodiments, this option can be used to automatically present content to a user based on a user's selection of a duration and a mood description.

Upon selecting option 218, a sub-menu including menu options 302, 304, and 306 may be presented to a user. Option 302 may be presented to enable a user to be automatically presented with content based on user selections of a duration and a mood description, option 304 may be presented to enable a user to be automatically presented with content based on previous activity, and option 306 may be presented to enable a user to view a history of previous activity during which media was automatically presented, to create future activity, and to take action with respect to that activity.

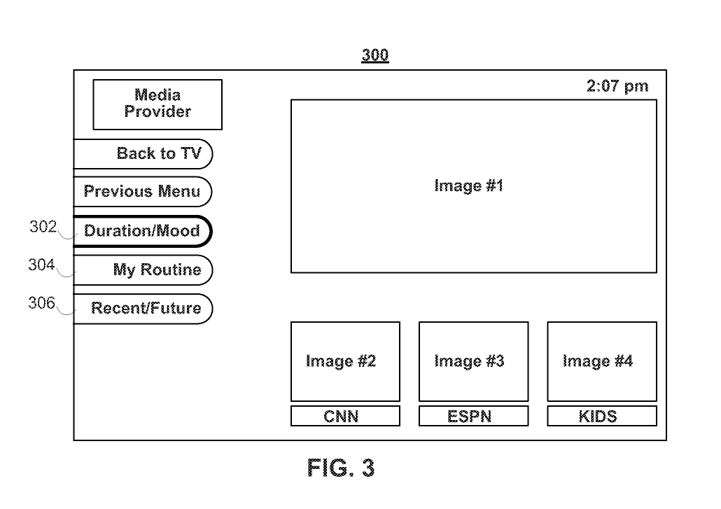

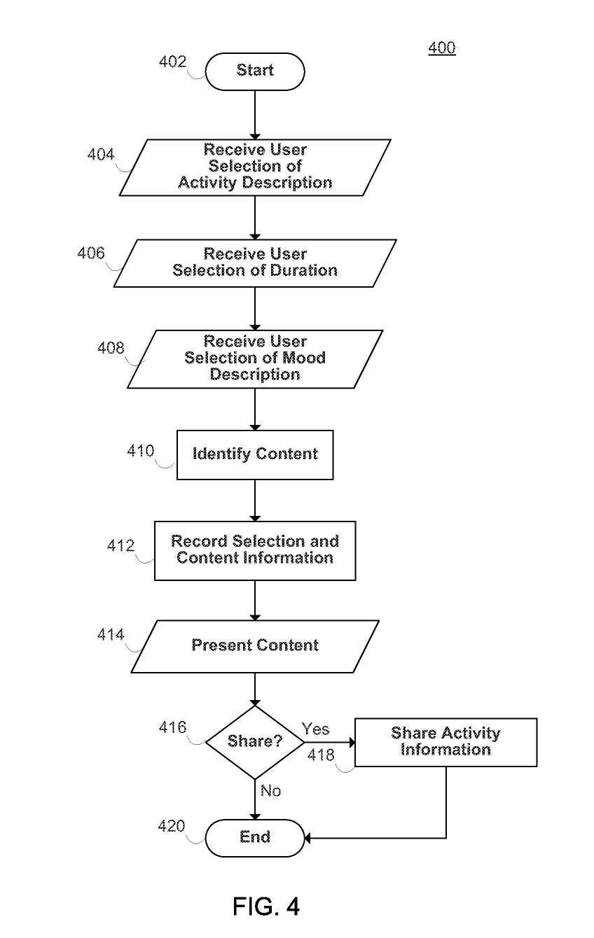

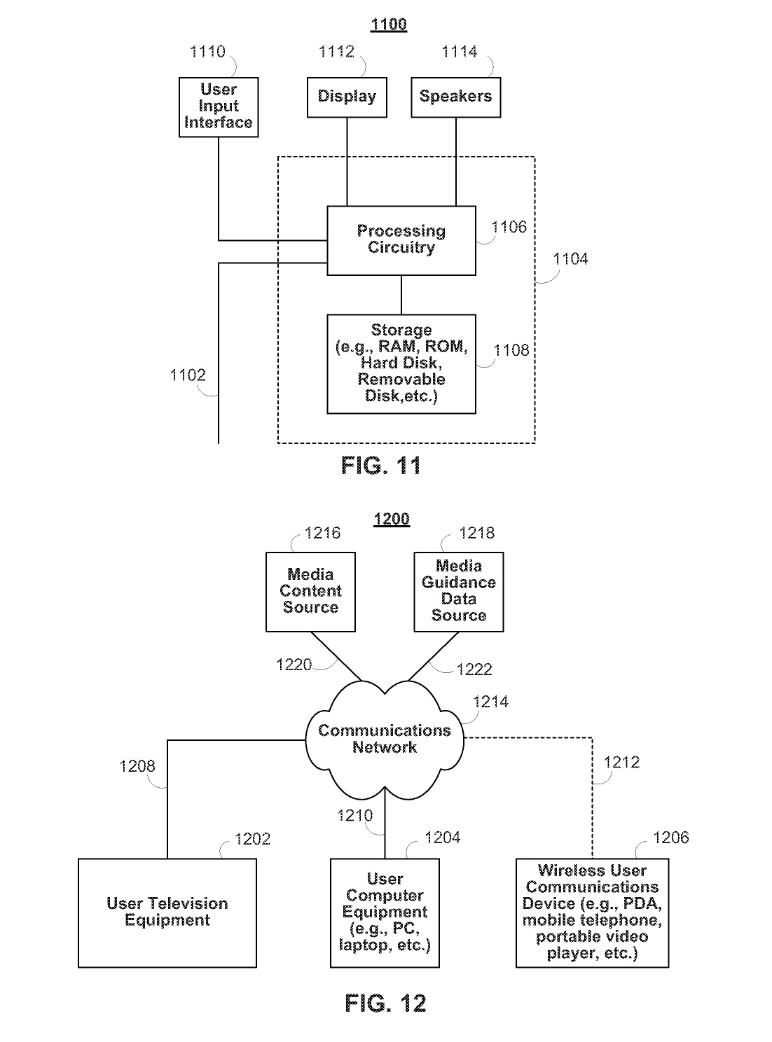

FIG. 4 presents a flow diagram of a process 400 for automatically presenting content to a user based on user selections of a duration and a mood description in accordance with some embodiments. This process may be performed, for example, in response to a user selecting option 302 of FIG. 3. As described further below, process 400 can be performed by control circuitry 1104 of FIG. 11.

As illustrated, after process 400 begins at 402, control circuitry 1104 may receive a user selection of a description of an activity at 404. An activity description may be any suitable description of an activity to be performed by a user. For example, an activity description may be “jumping rope,” “running,” “dancing,” “eating dinner,” “reading a book,” “going for a walk,” “studying,” and/or any other suitable activity description.

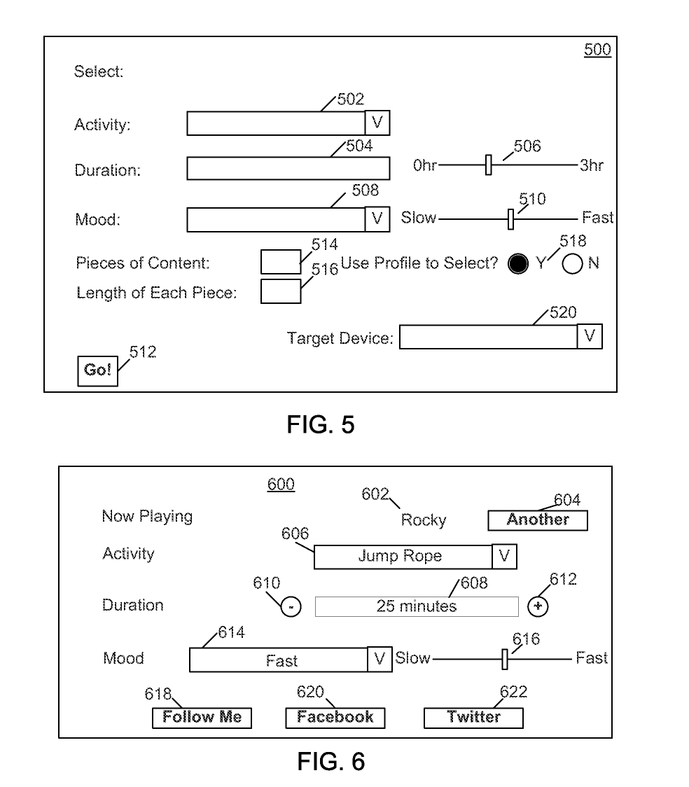

Any suitable mechanism for receiving this selection may be used in some embodiments. For example, control, circuitry 1104 may present a user interface such as user interface 500 of FIG. 5 and receive a user selection of an activity description from a user input interface 1110 (e.g., a remote control; as described further below in connection with FIG. 11) in some embodiments. More particularly, for example, control circuitry 1104 may receive an activity description selection from a drop-down menu 502, or may receive a new activity description entered into menu 502, from user input interface 1110 in accordance with some embodiments.

At 406, control circuitry 1104 may receive a selection of a duration for the activity. This duration can he any suitable period of time. For example, this duration can be 5 minutes, 30 minutes, 1.5 hours, 3 hours, until 8:30 pm, until an upcoming reminder, etc. In some embodiments, this selection may be limited to certain pre-defined options.

Any suitable mechanism for receiving this selection may be used in some embodiments. For example, control circuitry 1104 may present a user interface such as user interface 500 of FIG. 5 and receive a user selection of a duration from a user input interface 1110 (e.g., a remote control; as described further below in connection with FIG. 11) in some embodiments. More particularly, for example, control circuitry 1104 may receive a user selection of a duration in response to the user entering the duration in field 504, or by the use moving a slider 506 until a desired duration is presented in field 504, from user input interface 1110 in accordance with some embodiments.

Control circuitry 1104 may also receive a user selection of a description of a mood for the activity at 408. This mood description may be any suitable description for the mood of the activity. For example, in some embodiments, the mood can be selected as being “fast,” “slow,” “quiet,” “loud,” “high energy,” “focused,” “light,” “heavy,” “poppy,” “classical,” “romantic,” “party,” “Christmas,” “patriotic,” etc. In some embodiments, this selection may be limited to certain pre-defined options.

Any suitable mechanism for receiving this selection may be used in some embodiments. For example control circuitry 1104 may present a user interface such as user interface 500 of FIG. 5 and receive a user selection of a mood description from a user input interface 1110 (e.g., a remote control; as described further below in connection with FIG. 11) in some embodiments. More particularly, for example, a user may select a mood by selecting a mood from a drop down menu 508, or by moving a slider 510 until a desired mood is presented in menu 508, from user input interface 1110 in accordance with some embodiments.

In some embodiments, default options for the activity, duration, and/or mood may be presented by control circuitry 1104. For example, the default options may be presented in menu 502, field 504, and menu 508 in some embodiments. Such default options can be selected by control circuitry 1104 based on any suitable criteria or criterion. For example, one or more default options can be specified by a user when setting up preferences or can be determined based on a user's profile. As another example, one or more default options can be selected based on a corresponding previously selected option. As yet another example, one or more default options can be selected based on a time of day, day of week, time of year, etc.

Control circuitry 1104 can then identify content to be presented at 410 when a user is ready to proceed, which can be indicated by control circuitry 1104 detecting that a user has selected a “Go!” button 512 of FIG. 5 or by any other suitable indication (such as a user selecting each of an activity description, a duration, and a mood description).

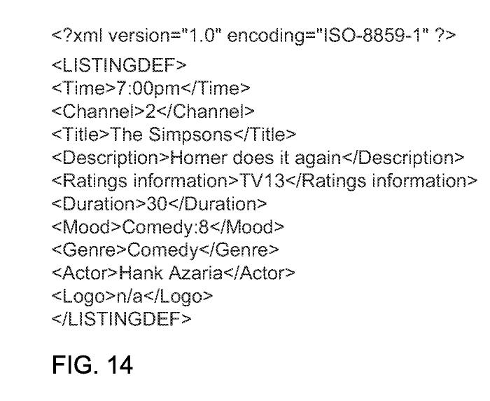

Any suitable mechanism for identifying content to he presented can he used in some embodiments. For example, in some embodiments, control circuitry 1104 can retrieve content information from storage (e.g., in an XML structure as illustrated in FIG. 14), filter the content information based on the mood description, and then identify the content closest in duration so the selected duration for presentation.

As another example, in some embodiments, control circuitry 1104 can determine a similarity between content and the duration and mood selections received from the user. More particularly, for example, control circuitry 1104 can do this by determining that the selected mood description corresponds so a particular numerical value on a range of values. Any suitable translation of a mood description so a numerical value can be used. For example, fast can be assigned a value of ten, slow can be assigned a value of one, and degrees of speed can be assigned values between ten and one.

In some variations of this example, a mood description can be multi-dimensional and the value assigned to this mood description can be a point in multi-dimensional space.

The determined value and the selected duration can each be weighted by control circuitry 1104 using any suitable weights (e.g., reflecting the relative importance of duration and mood). Control circuitry 1104 can then combine the weighted values together to determine a desired score.

Next, control circuitry 1104 can retrieve available content information from storage 1108 (as described below in FIG. 11). Any suitable mechanism can be used so retrieve this content information. For example, in some embodiments, the content information can be retrieved by control circuitry 1104 from storage 1108 using an XML structure as illustrated in FIG. 14. Content with the closest score (which can be calculated in the same way for the content) to the desired score can then be identified by control circuitry 1104 for presentation.

More particularly, for example, the desired score can be calculated by control circuitry 1104 as

Desired_Score=W_{DURATION}*Duration+W_{MOOD}*Mood_Value

and the score of each piece of content can be calculated as

Content_Score=W_{DURATION}*Length+W_{MOOD}*Mood_Value_Content

where:
Desired Score is the score of the activity;
Content Score is the score of the content;
W_{DURATION} is the weight associated with the duration;
Duration is the duration of the activity;
W_{MOOD} is the weight associated with the mood;
Mood_Value is the value associated with the mood description;
Length is the length of the content.; and
Mood_Value_Content is the value associated with the mood of the content.
   The content with the Content Score closest to the Desired_Score can be identified by control circuitry 1104 as content to be presented.

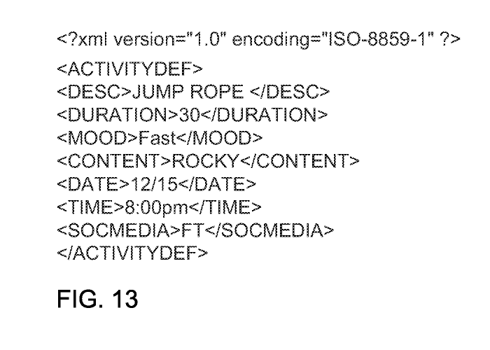

In some embodiments, when identifying content, previous selections for the same activity description, duration, and/or mood description can be retrieved from storage 1108 (e.g., using the XML structure illustrated in FIG. 13) and compared by control circuitry 1104 to determine if particular content is or is not liked by the user, if particular content was or was not recently presented to the user, and/or if there is any other reason that particular content should or should not be presented to the user. This determination can then affect the identification of content by control circuitry 1104 as appropriate.

At 412, the selections of the activity description, the duration, the mood description, and the content to be presented, the date, the time, and/or any other suitable data can then be recorded by control circuitry 1104 to storage 1108 in some embodiments. For example, in some embodiments, this data can be recorded by control circuitry 1104 writing an XML structure to storage 1108 as illustrated in FIG. 13. As described above and further below, this data may be used to aid in future identification of content to be presented.

Control circuitry 1104 can then present the content to the user at 414. Any suitable mechanism for presenting the content can be used in some embodiments. For example, if the content is currently available on broadcast television, a tuner in control circuitry 1104 may be configured to tune to the content. As another example, if the content is available on demand, the content may be ordered for presentation by control circuitry 1104. As yet another example, if the content is available on the Internet, a Web browser may be opened and directed to the content by control circuitry 1104.

Control circuitry 1104 can also determine at 416 whether information relating to the activity, such as the activity description, the duration, the mood description, the identified content, the date, the time, and/or any other suitable data, is to be shared on social media. Any suitable basis for making this determination may be used in some embodiments. For example, whether information is to be shared on social media can be determined based on preferences, previous user selections to share information, etc.

If it is determined that the information is to be shared, the information may then be shared in any suitable fashion by control circuitry 1104 at 418. For example, the information may be submitted by control circuitry 1104 transmitting a suitable message to FACEBOOK, to TWITTER, and/or to any other suitable social media platform. FACEBOOK is a trademark owned by Facebook, Inc., and TWITTER is a trademark owned by Twitter, Inc.

After sharing the information at 418, or if it is determined that the information is not to be shared, then process 400 can terminate at 420.

In some embodiments, identifying content at 410, recording selection and content information at 412, presenting content at 414, determining whether to share content activity information at 416, and sharing activity information at 418 can be performed by control circuitry 1104 for only a single piece of content that corresponds to the selected duration or for multiple pieces of content that when combined correspond to the selected duration. Any suitable mechanism for determining how many and which pieces of content are to be presented during the selected duration can he used in some embodiments.

For example, in some embodiments, control circuitry 1104 can receive one or more criteria selections of the number of pieces of content desired, how long each piece of content is to be presented, if a profile of a user is to be used to select individual pieces of content, whether the pieces of content should be equal portions of the selected duration, and/or any other suitable criteria or criterion. As shown in FIG. 5, such criteria may be received by control circuitry 1104, for example, in response no the user entering, using a user input interface 1110, a number of pieces of content in field 514, a length of each piece in field 516 of (if nothing is entered in field 516, the pieces of content may be presented for equal portions of the duration in some embodiments), and whether the user's profile is to be used with radio buttons 518 (or, alternatively, the pieces are to be selected randomly, for example).

If multiple pieces of content are to be presented, control circuitry 1104 can then cause identifying of content at 410, recording of selection and content information at 412, presenting of content at 414, determining whether to share content activity information at 416, and sharing of activity information at 418 (if applicable) to be performed once for each piece of content to be presented. For each piece of content, the duration can be a sub-duration of the duration received by control circuitry 1104 at 406 based on the criteria entered in fields 514 and/or 516.

For example, control circuitry 1104 may receive a user input specifying an activity duration of 10 minutes, a “happy” mood and three pieces of content to be presented during the activity. In response, control circuitry 1104 may transmit a query to a database to retrieve a list of content matching the happy mood. In particular, control circuitry 1104 may retrieve from the database a list of content that is tagged as being upbeat or specified by a content provider (or other users) as being of the specified mood (e.g., happy). For example, control circuitry 1104 may receive a list that includes 100 pieces of content that vary in length from 3 minutes to 5 minutes. In order to select which of the 100 pieces of content will he presented to the user during the activity, control circuitry 1104 may first determine which of the 100 pieces of content matches preferences or profile of the user. The subset of the 100 pieces of content that matches the user preferences or profile may include 15 pieces of content.

In some implementations, control circuitry 1104 may process the content in the subset to determine a length of each piece of content in the subset. For example, control circuitry 1104 may retrieve a data structure associated with each piece of content from memory to determine the playback length of the corresponding piece of content. In response to determining that the total length of the pieces of content in the subset is less than or equal to the total duration of the activity, control circuitry 1104 may select, all of the content in the subset for presentation to the user during the activity. In the case that the length of the combination of all of the pieces of content in the subset is less than the specified duration, control circuitry 1104 may supplement the content in the subset with one or more pieces of content originally retrieved that match the specified mood. Control circuitry 1104 may determine how many more pieces of content are needed to make the playback length of the subset substantially equal no the specified duration. For example, control circuitry 1104 may determine that 3 minutes remain to be filled in the specified duration and may accordingly search for content that is 3 minutes long, matches the specified mood but may not match the user's preferences.

In response to determining that the total playback length of the pieces of content in the subset is more than the total duration of the activity, control circuitry 1104 may select a portion of the contents in the subset of pieces of content randomly or based on other user inputs to make the length of the selected content match the specified duration. For example, control circuitry 1104 may randomly select content in the subset until the total playback length of the selected content matches the specified duration. Alternatively or in addition, control circuitry 1104 may receive input from the user specified how many contents to playback during the activity. Control circuitry 1104 may select a number of content matching the number specified by the user to meet the specified duration. For example, the user may specify the desire for 3 pieces of different content to be presented during the activity specified to be 10 minute in duration. In response, control circuitry 1104 may search the subset of pieces of content for three pieces of content of equal length (e.g., 3.33 minutes in length) for presentation to the user during the activity. Alternatively, control circuitry 1104 may search the subset of pieces of content for one very long piece of content and two shorter pieces of content that when combined into a playlist playback for a duration of time matching the specified duration of the activity.

In some embodiments, large pieces of content, such as a movie, may be available as smaller pieces of content, such as a clip from the movie. These smaller pieces of content may each have a specified length and a specified mood. Each such smaller piece of content may have an associated information structure, such as XML structure of FIG. 14, that can be used to provide the length and mood information to control circuitry 1104. When identifying content to be presented, control circuitry 1104 can search through different smaller pieces of content (e.g., movie clips) from a larger piece of content (e.g., a movie) to identify the portions of the movie that suit the duration and mood specified for an activity. In some embodiments, control circuitry 1104 may select for playback to the user during the activity, only a portion of each piece of content. For example, the portion selected may be the most popular segment of a show. In particular, control circuitry 1104 may be instructed to present three pieces of content. In addition, control circuitry 1104 may identify three pieces of content matching the specified mood that have a playback length combined to be longer than the specified duration of the activity. In response, control circuitry 1104 may select, equal or non-equal length segments of each of the three pieces of content for presentation to the user during the activity. The segment that is selected may be the beginning few minutes, the middle, the end or a combination thereof of the particular pieces of content.

In some embodiments, activities configured on one device can cause content to be presented on another device. For example, as described further below in connection with FIG. 12, one user equipment device 1202, 1204, or 1206 can be used to configure an activity which causes content to be presented on another user equipment device 1202, 1204, or 1206. As a more particular example, a user may be able to set up an activity on a home set-top box that causes content to be presented on the user's mobile phone. As shown in FIG. 5, in some embodiments, control circuitry 1104 can receive a user selection of a target device for content (e.g., the user's mobile phone) from the user using a menu 520.

It should be understood that some of the above steps of the flow diagram of FIG. 4 may be executed or performed in an order or sequence other than the order and sequence shown and described in the figure. Also, some of the above steps of the flow diagram of FIG. 4 may be executed or performed substantially simultaneously where appropriate or in parallel to reduce latency and processing times.

Turning to FIG. 6, an example of a user interface 600 that may be displayed by control circuitry 1104 in accordance with some embodiments when content is being presented is shown. As illustrated, the name of content being presented, here the movie “Rocky,” may be presented in a field 602. In the event that the user does not like the content being presented, the user may be able to select an “another” button 604 in some embodiments. In response to this selection, other content may then be identified and presented (and the corresponding data recorded and/or shared) by control circuitry 1104 as described above.

As also illustrated, the activity description may be presented in a menu 606. In some embodiments, in the event that the user wants to change the activity description (e.g., because the user has decided to change activities), control circuitry 1104 may receive a different activity description (or enter a new one) from the user using menu 606. If the user changes the activity description, the newly selected activity description may then be recorded and/or shared by control circuitry 1104 as described above.

Likewise, the duration may be presented using field 608. In some embodiments, this field may count down as time passes. In some embodiments, in the event that the user wants to change the duration, control circuitry 1104 may receive a new duration by the user pressing add time and/or decrease time buttons 610 and 612, or by the user entering a new duration in field 608. If the user changes the duration, the newly selected duration may then be recorded and/or shared by control circuitry 1104 as described above.

As further illustrated, the mood description may be presented in a menu 614. In some embodiments, in the event that the user wants to change the mood description (e.g., because the user has decided to change the mood), control circuitry 1104 may receive a different mood description (or enter a new one) by the user using menu. 614 or by the user moving slider 616. If the user changes the mood description, the newly selected mood description may then be recorded and/or shared as described above.

In some embodiments, a change in the mood description can be received by control circuitry 1104 in response no the user pressing a “follow me” button 613. Upon pressing this button, the user's activity level and/or environmental conditions can be monitored by control circuitry 1104 to determine a new mood description in some embodiments.

For example, a user's activity level may be determined by control circuitry 1104 by monitoring motion and/or biometric data of a user in some embodiments. Motion of the user can be monitored by control circuitry 1104 using a light or heat sensor (e.g., such as a camera) to monitor the user, using a motion detector (e.g., an accelerometer) attached no, or being held by, the user, etc. Biometric data of the user can be monitored by control circuitry 1104 using any suitable biometric data measuring device. Based on this monitoring, a new mood can be selected by control circuitry 1104 that corresponds to a detected activity level of the user.

As another example, environmental conditions can be monitored by control circuitry 1104 by detecting the sound and/or light levels, sound and/or light repetitions, etc. of the environment. Such levels and/or repetitions can indicate that mood of a user is quiet, festive, has a certain tempo or beat, etc.

In some embodiments, if a user changes the duration and/or the mood description., new content may automatically be identified and presented (as described above) by control circuitry 1104, the user may be asked by control circuitry 1104 whether new content should be identified and presented, or the user may be required by control circuitry 1104 to select “another” button 604 to have new content corresponding to the new duration and/or the new mood description identified and presented by control circuitry 1104.

In some embodiments, control circuitry 1104 can receive a user selection no share information using social media as described above using one or more buttons 620 and/or 622.

Once the duration expires, the content presentation may automatically be stopped by control circuitry 1104 in some embodiments until the user makes a new selection of an activity description, a duration, and a mood description as described above. Alternatively, in some embodiments, another piece of content may be automatically identified and presented (and the corresponding data recorded and/or shared) by control circuitry 1104 following the expiration of the duration as described above.

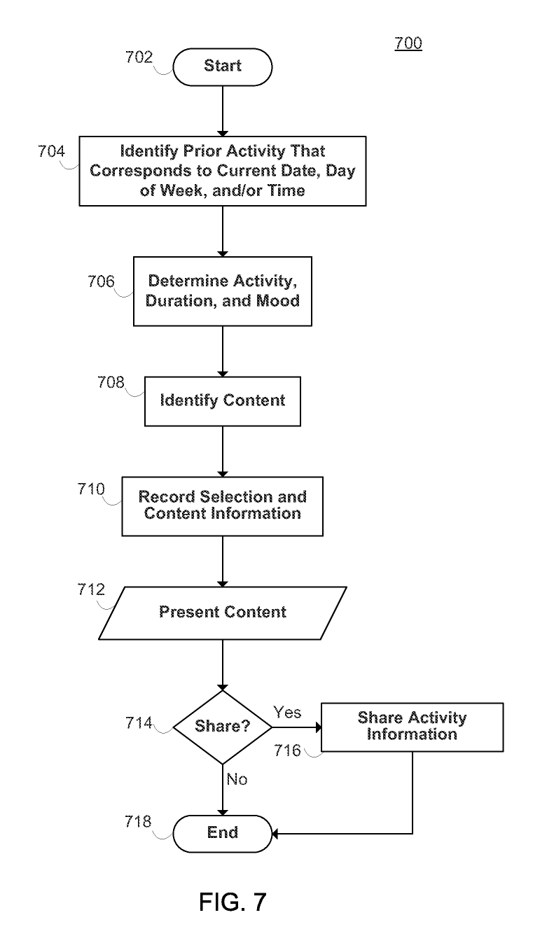

FIG. 7 presents a flow diagram of a process 700 for automatically presenting content to a user based on a previous activity in accordance with some embodiments. This process may be performed, for example, by control circuitry 1104 in response to a user selecting option 304 of FIG. 3.

As illustrated, after process 700 begins at 702, control circuitry 1104 may identify prior activity that corresponds to the current date, day of week, and/or time at 704. Identifying prior activity may be performed by control circuitry 1104 in any suitable manner. For example, prior activity may be identified by control circuitry 1104 based on an activity previously performed by the user on most weekdays at approximately the current time. As another example, prior activity may be identified by control circuitry 1104 based on activity previously performed by the user at approximately the same time as the current time on the same day of the week as the current day of the week.

Any suitable mechanism can be used by control circuitry 1104 for identifying prior activity. For example, in some embodiments, records of prior activities can be read from storage 1108 by control circuitry 1104 as XML structures (e.g., as illustrated in FIG. 13), those records searched by control circuitry 1104 for suitable characteristics (e.g., such as having a certain time), and those activities with suitable characteristics identified by control circuitry 1104 as corresponding to the current date, day of week, and/or time

At 706, control circuitry 1104 can determine an activity description, a duration, and a mood description for the current activity based on the identified prior activity. Any suitable manner of determining the activity description, the duration, and the mood description can be used in some embodiments. For example, the activity description, the duration, and the mood description can be determined by control circuitry 1104 as being the same as these parameters for the most frequently identified prior activity.

Control circuitry 1104 can then identify content to be presented at 708. Any suitable mechanism for identifying content to be presented can be used in some embodiments. For example, in some embodiments, control circuitry 1104 can identify content similarly to the manner in which content is described as being identified above in connection with 410 of FIG. 4.

At 710, the determinations of the activity description, the duration, the mood description, and the content to be presented, the date, the time, and/or any other suitable data can then be recorded by control circuitry 1104 to storage 1108 in some embodiments. For example, in some embodiments, this data can be recorded by control circuitry 1104 writing an XML structure to storage 1108 as illustrated in FIG. 13. As described above and further below, this data may be used to aid in future identification of content to he presented.

Control circuitry 1104 can then present the content to the user at 712. Any suitable mechanism for presenting the content can be used in some embodiments. For example, if the content is currently available on broadcast television, a tuner in control circuitry 1104 may be configured to tune to the content. As another example, if the content is available on demand, the content may be ordered for presentation by control circuitry 1104. As yet another example, if the content is available on the Internet, a Web browser may be opened and directed to the content by control circuitry 1104.

Control circuitry 1104 can also determine at 714 whether information relating to the activity, such as the activity description, the duration, the mood description, the identified content, the date, the time, and/or any other suitable data, is to be shared on social media. Any suitable basis for making this determination may be used in some embodiments. For example, whether information is to be shared on social media can be determined based on preferences, previous user selections to share information, etc.

If it is determined that the information is to be shared, the information may then be shared in any suitable fashion by control circuitry 1104 at 716. For example, the information may be submitted by control circuitry 1104 transmitting a suitable message to FACEBOOK, to TWITTER, and/or to any other suitable social media platform.

After sharing the information at 716, or if it is determined that the information is not to be shared, then process 700 can terminate at 718.

It should be understood that some of the above steps of the flow diagram of FIG. 7 may be executed or performed in an order or sequence other than the order and sequence shown and described in the figure. Also, some of the above steps of the flow diagram of FIG. 7 may be executed or performed substantially simultaneously where appropriate or in parallel to reduce latency and processing times.

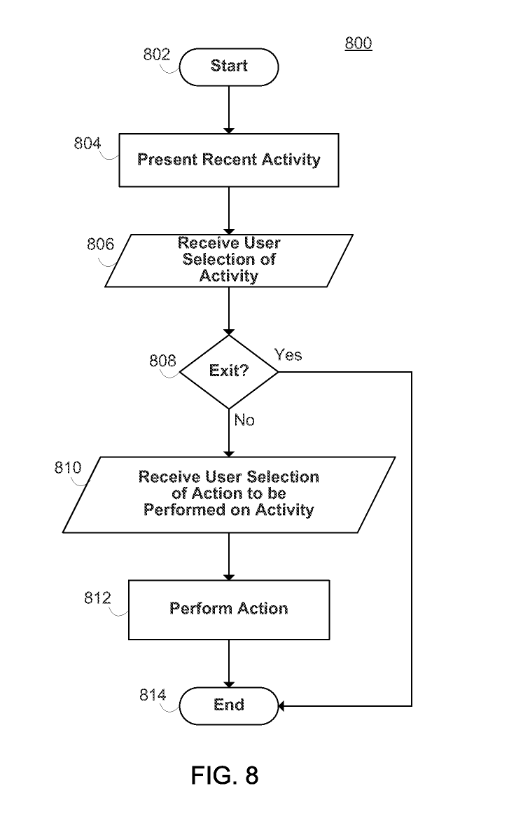

Referring back to FIG. 3, if a user selects a “recent/future” option 306, a process, such as process 800 of FIG. 8, for performing actions on recent or future activities may be performed by control circuitry 1104 in some embodiments.

As illustrated, after process 800 begins at 802, control circuitry 1104 may present recent activities to the user at 804 in some embodiments. Any suitable mechanism can be used to present recent activities to the user in some embodiments.

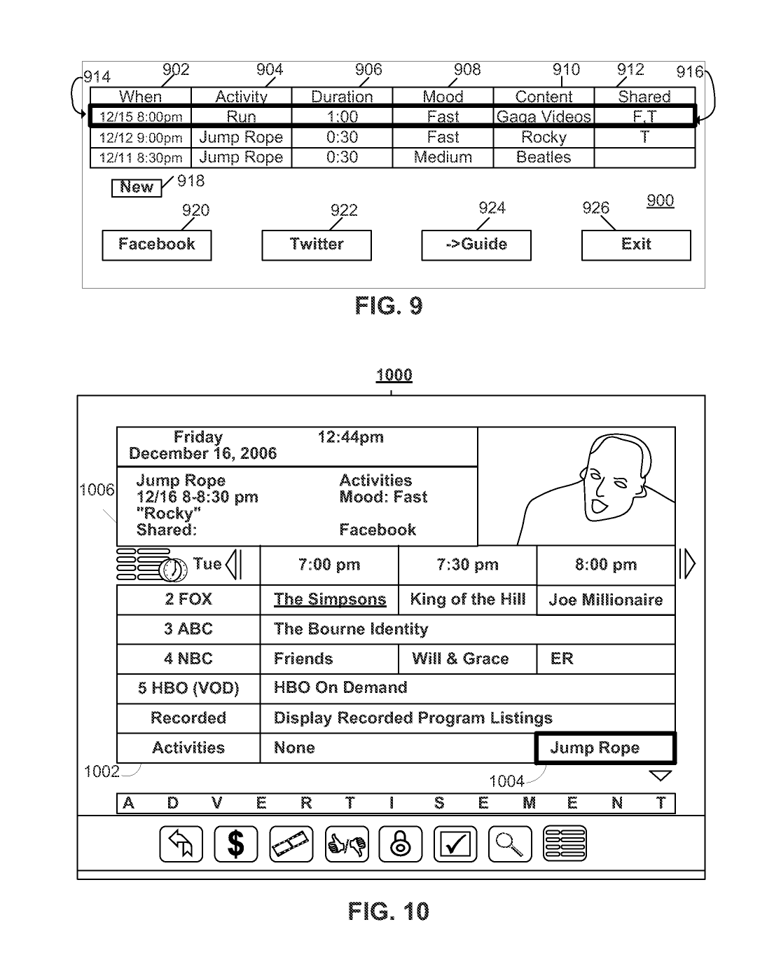

For example, a user interface such as user interface 900 of FIG. 9 can be used by control circuitry 1104 to present recent activities to the user. As illustrated, for each activity, user interface 900 can be used by control circuitry 1104 to indicate when the activity occurred in field 902, a description of the activity in field 904, a duration of the activity in field 906, a mood description of the activity in field 908, an identifier for content presented during the activity in field 910, and/or one or more indicators indicating whether the activity was shared on social media in field 912.

For example, as shown for activity 914, control circuitry 1104 can indicate that the activity occurred on December 15th at 8:00 pm, the description of the activity performed was “Run,” the duration was 1 hour, the description of the mood of the activity was “fast,” the content presented was “Gaga Videos,” and information on the activity was shared on FACEBOOK and TWITTER.

Any suitable mechanism can be used by control circuitry 1104 to populate the activities list shown in FIG. 9. For example, in some embodiments records of activities can be read from storage 1108 by control circuitry 1104 as XML structures (e.g., as shown in FIG. 13), the records sorted by control circuitry 1104, and the records listed by control circuitry 1104 in the list of FIG. 9.

Returning to FIG. 8, control circuitry 1104 can then receive a user selection of an activity presented or an indication that the user would like to create a new activity at 806. Any suitable mechanism for selecting an activity presented can be used in some embodiments. For example, a highlight field 916 can be positioned around an activity such as activity 914 using arrow keys on a user input interface 1110 (as described below), and the top activity can be selected by default by control circuitry 1104.

Similarly, any suitable mechanism for enabling the user to select to create a new activity can be used by control circuitry 1104 in some embodiments. For example, the user can be able no select to create a new activity by selecting “new” button 918 using a user input interface 1110 in some embodiments. In response to the user selecting the new button, the user may be prompted by control circuitry 1104 to create a new activity (e.g., as described above in connection with FIGS. 4 and 5) and to enter a future data and time, and a re-occurrence frequency if desired, for the activity. However, once the activity is created, rather than presenting the content as described above in FIG. 4, the activity can be added by control circuitry 1104 to the list of activities in user interface 900 of FIG. 9, a reminder for the activity can he set by control circuitry 1104, a record of the activity recorded to storage 1108 by control circuitry 1104 using an XML structure (e.g., as illustrated in FIG. 13), and the activity can be selected for subsequent action by control circuitry 1104.

Next, at 808, control circuitry 1104 can determine whether the user wants to exit the current interface by monitoring which of buttons 920, 922, 924, and 926 is pressed next by the user. If button 926 is pressed, then process 800 may terminate at 814. Otherwise, control circuitry 1104 may receive at 810 a user selection of an action to be performed based on the one of buttons 920, 922, and 924 pressed and may perform the action at 812 as described below, and then process 800 may terminate at 814.

If the user presses “FACEBOOK” button 920 or “TWITTER” button 922, then information for the selected activity may be submitted by control circuitry 1104 to FACEBOOK or TWITTER at 812.

If the user presses “→Guide” button 924, the selected activity may be copied to a program listings grid at 812, such as programs listing grid 1000 displayed in FIG. 10, by control circuitry 1104. As shown, an “activities” channel 1002 may be created by control circuitry 1104 and a listing 1004 may be entered by control circuitry 1104 at 8:00 pm for 30 minutes entitled “Jump Rope.” As also shown, a program information region 1006 presented by control circuitry 1104 may also list information corresponding to the activity, such as the activity description, the duration, the mood description, the time, the date, the identified content to be presented, whether information on the activity has been or will be shared on social media, and/or any other suitable information.

In some embodiments, once a future activity is present in a program guide grid, control circuitry 1104 can receive a change in the parameters of the activity from the user through the grid interface. For example, in some embodiments, control, circuitry 1104 can receive a change in the duration of an activity by the user highlighting the cell for the activity using a user input interface 1110 and then pressing an up arrow button on user input interface 1110 to increase the duration of the activity.

Users may access content and the media guidance application (and its display screens described above and below) from one or more of their user equipment devices. FIG. 11 shows a generalized embodiment of illustrative user equipment device 1100. More specific implementations of user equipment devices are discussed below in connection with FIG. 12. User equipment device 1100 may receive content and data via input/output (hereinafter “I/O”) path 1102. I/O path 1102 may provide content (e.g., broadcast programming, on-demand programming, Internet content, content available over a local area network (LAN) or wide area network (WAN), and/or other content) and data to control circuitry 1104, which includes processing circuitry 1106 and storage 1108. Control circuitry 1104 may be used to send and receive commands, requests, and other suitable data using I/O path 1102. I/O path 1102 may connect control circuitry 1104 (and specifically processing circuitry 1106) to one or more communications paths (described below). I/O functions may be provided by one or more of these communications paths, but are shown as a single path in FIG. 11 to avoid overcomplicating the drawing.

Control circuitry 1104 may be based on any suitable processing circuitry such as processing circuitry 1106. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or a supercomputer. In some embodiments, processing circuitry may be distributed across multiple separate processors or processing units, for example, multiple of the same type of processing units (e.g., two Intel Core i7 processors) or multiple different processors e.g., an Intel Core i5 processor and an Intel Core i7 processor). In some embodiments, control circuitry 1104 executes instructions for a media guidance application stored in memory (i.e., storage 1108).

In client-server based embodiments, control circuitry 1104 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 12). In addition, communications circuitry may include circuitry that enables peer-to-peer communication of user equipment devices, or communication of user equipment devices in locations remote from each other (described in more detail below).

Memory may be an electronic storage device provided as storage 1108 that is part of control circuitry 1104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (PD) recorders, BLU RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1108 may be used to store various types of content described herein as well as media guidance information, described above, and guidance application data, described above. Nonvolatile memory may also be used (e.g., to launch a boot-up routine and other instructions). Cloud-based storage, described in relation to FIG. 12, may be used to supplement storage 1108 or instead of storage 1108.

Control circuitry 1104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1104 may also include scaler circuitry for upconverting and downconverting content into the preferred output format of the user equipment 1100. Circuitry 1104 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized hardware processors. Multiple tuners may be provided to handle simultaneous tuning functions (e.g., watch and record functions, picture-in-picture (PIP) functions, multiple-tuner recording, etc.). If storage 1108 is provided as a separate device from user equipment 1100, the tuning and encoding circuitry (including multiple tuners) may be associated with storage 1108.

A user may send instructions to control circuitry 1104 using user input interface 1110. User input interface 1110 may be any suitable user interface, such as a remote control, mouse, trackball, keypad, keyboard, touch screen, touchpad, stylus input, joystick, voice recognition interface, or other user input interfaces. Display 1112 may be provided as a stand-alone device or integrated with other elements of user equipment device 1100. Display 1112 may be one or more of a monitor, a television, a liquid crystal display (LCD) for a mobile device, or any other suitable equipment for displaying visual images. In some embodiments, display 1112 may be HDTV-capable. In some embodiments, display 1112 may be a 3D display, and the interactive media guidance application and any suitable content may be displayed in 3D. A video card or graphics card may generate the output to the display 1112. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 1104. The video card may be integrated with the control circuitry 1104. Speakers 1114 may be provided as integrated with other elements of user equipment device 1100 or may be standalone units. The audio component of videos and other content displayed on display 1112 may he played through speakers 1114. In some embodiments, the audio may he distributed to a receiver (non shown), which processes and outputs the audio via speakers 1114.

The guidance application may be implemented using any suitable architecture. For example, it may be a stand-alone application wholly implemented on user equipment device 1100. In such an approach, instructions of the application are stored locally, and data for use by the application is downloaded on a periodic basis (e.g., from an out-of-band feed, from an Internet resource, or using any other suitable approach). In some embodiments, the media guidance application is a client-server based application. Data for use by a thick or thin client implemented on use equipment device 1100 is retrieved on-demand by issuing requests to a server remote to the user equipment device 1100. In one example of a client-server based guidance application, control circuitry 1104 runs a web browser that interprets web pages provided by a remote server.

In some embodiments, the media guidance application is downloaded and interpreted or otherwise run by an interpreter or virtual machine (run by control circuitry 1104). In some embodiments, the guidance application may be encoded in the ETV Binary Interchange Format (EBIF), received by control circuitry 1104 as part of a suitable feed, and interpreted by a user agent running on control circuitry 1104. For example, the guidance application may be an EBIF application. In some embodiments, the guidance application may be defined by a series of JAVA-based files that are received and run by a local virtual machine or other suitable middleware executed by control circuitry 1104. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 1100 of FIG. 11 can be implemented in system 1200 of FIG. 12 as user television equipment 1202, user computer equipment 1204, wireless user communications device 1206, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand alone device or may be part of a network of devices. Various network configurations of devices may be implemented and are discussed in more detail below.

A user equipment device utilizing at least some of the system features described above in connection with FIG. 11 may not be classified solely as user television equipment 1202, user computer equipment 1204, or a wireless user communications device 1206. For example, user television equipment 1202 may, like some user computer equipment 1204, be Internet-enabled allowing for access to Internet content, while user computer equipment 1204 may, like some television equipment 1202, include a tuner allowing for access to television programming. The media guidance application may have the same layout on various different types of user equipment or may be tailored to the display capabilities of the user equipment. For example, on user computer equipment 1204, the guidance application may be provided as a web site accessed by a web browser. In another example, the guidance application may be scaled down for wireless user communications devices 1206.

In system 1200, there is typically more than one of each type of user equipment device but only one of each is shown in FIG. 12 to avoid overcomplicating the drawing. In addition, each user may utilize more than one type of user equipment device and also more than one of each type of user equipment device.

In some embodiments, a user equipment device (e.g., user television equipment 1202, user computer equipment 1204, wireless user communications device 1206) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device. In some embodiments, the second screen device can be used so as a target device for a content presentation in connection with an activity as discussed above in connection with FIG. 5.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 1214. Namely, user television equipment 1202, user computer equipment 1204, and wireless user communications device 1206 are coupled to communications network 1214 via communications paths 1208, 1210, and 1212, respectively. Communications network 1214 may be one or more networks including the Internet, a mobile phone network, mobile voice or data network (e.g., a 4G or LTE network), cable network, public switched telephone network, or other types of communications network or combinations of communications networks. Paths 1208, 1210, and 1212 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 1212 is drawn with dotted lines to indicate that in the exemplary embodiment shown in FIG. 12 it is a wireless path and paths 1208 and 1210 are drawn as solid lines to indicate they are wired paths (although these paths may be wireless paths, if desired). Communications with the user equipment devices may be provided by one or more of these communications paths, but are shown as a single path in FIG. 12 to avoid overcomplicating the drawing.

Although communications paths are not drawn between user equipment devices, these devices may communicate directly with each other via communication paths, such as those described above in connection with paths 1208, 1210, and 1212, as well other short-range point-to-point communication paths, such as USE cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 1214.

System 1200 includes content source 1216 and media guidance data source 1218 coupled to communications network 1214 via communication paths 1220 and 1222, respectively. Paths 1220 and 1222 may include any of the communication paths described above in connection with paths 1208, 1210, and 1212. Communications with the content source 1216 and media guidance data source 1218 may be exchanged over one or more communications paths, but are shown as a single path in FIG. 12 to avoid overcomplicating the drawing. In addition, there may be more than one of each of content source 1216 and media guidance data source 1218, but only one of each is shown in FIG. 12 to avoid overcomplicating the drawing. (The different types of each of these sources are discussed below.) If desired, content source 1216 and media guidance data source 1218 may be integrated as one source device. Although communications between sources 1216 and 1218 with user equipment devices 1202, 1204, and 1206 are shown as through communications network 1214, in some embodiments, sources 1216 and 1218 may communicate directly with user equipment devices 1202, 1204, and 1206 via communication paths (not shown) such as those described above in connection with paths 1208, 1210, and 1212.

Content source 1216 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 1216 may be the originator of content (e.g., a television broadcaster, a Webcast provider, etc.) or may not be the originator of content (e.g., an on-demand content provider, an Internet provider of content of broadcast programs for downloading, etc.). Content source 1216 may include cable sources, satellite providers, on-demand providers, Internet providers, over-the-top content providers, or other providers of content. Content source 1216 may also include a remote media server used to store different types of content (including video content selected by a user), in a location remote from any of the user equipment devices. Systems and methods for remote storage of content, and providing remotely stored content to user equipment are discussed in greater detail in connection with Ellis et. al., U.S. Pat. No. 7,761,892, issued Jul. 20, 2010, which is hereby incorporated by reference herein in its entirety.

Media guidance data source 1213 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 1218 may he provided to users equipment using a client-server approach. For example, a user equipment device may pull media guidance data from a server, or a server may push media guidance data to a user equipment device. In some embodiments, a guidance application client residing on the user's equipment may initiate sessions with source 1218 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 1218 may provide user equipment devices 1202, 1204, and 1206 the media guidance application itself or software updates for the media guidance application.

Media guidance applications may be, for example, stand-alone applications implemented on user equipment devices. For example, the media guidance application may be implemented as software or a set of executable instructions which may be stored in storage 1108, and executed by control circuitry 1104 of a user equipment device 1100. In some embodiments, media guidance applications may be client-server applications where only a client application resides on the user equipment device, and a server application resides on a remote server. For example, media guidance applications may be implemented partially as a client application on control circuitry 1104 of user equipment device 1100 and partially on a remote server as a server application (e.g., media guidance data source 1218) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 1202, 1204, and 1206 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 1200 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 12.

In one approach, user equipment devices may communicate with each other within a home network. User equipment devices can communicate with each other directly via short-range point-to-point communication schemes described above, via indirect paths through a hub or other similar device provided on a home network, or via communications network 1214. Each of the multiple individuals in a single home may operate different user equipment devices on the home network. As a result, it may be desirable for various media guidance information or settings to be communicated between the different user equipment devices. For example, in may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Pat. No. 3,046,801, issued Oct. 25, 2011, which is hereby incorporated by reference herein in its entirety.

In a third approach, users of user equipment devices inside and outside a home can use their media guidance application to communicate directly with content source 1216 to access content. Specifically, within a home, users of user television equipment 1202 and user computer equipment 1204 may access the media guidance application to navigate among and locate desirable content. Users may also access the media guidance application outside of the home using wireless user communications devices 1206 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 1214. These cloud resources may include one or more content sources 1216 and one or more media guidance data sources 1218. In addition or in the alternative, the remote computing sites may include other user equipment devices, such as user television equipment 1202, user computer equipment 1204, and wireless user communications device 1206. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture a devices, such as camcorders, digital cameras with video mode, audio recorders, mobile phones, and handheld computing devices, to record content. The user can upload content to a content storage service on the cloud either directly, for example, from user computer equipment 1204 or wireless user communications device 1206 having content capture feature. Alternatively, the user can first transfer the content to a user equipment device, such as user computer equipment 1204. The user equipment device storing the content uploads the content to the cloud using a data transmission service on communications network 1214. In some embodiments, the user equipment device itself is a cloud resource, and other user equipment devices can access the content directly from the user equipment device on which the use stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 11.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, BLU-RAY discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

1. A method for automatically identifying content to be presented to a user, the method comprising:
determining a duration during which a user will be performing an activity;
determining a mood description of the activity;
retrieving from memory characteristics of a plurality of the entertainment content that include length of each of the plurality of entertainment content and a mood description of each of the plurality of entertainment content;
comparing the retrieved characteristics with the duration of the activity and the mood description of the activity;
automatically selecting entertainment content from the plurality of entertainment content to be presented during the activity; and
causing the entertainment content to be presented to the user.

2. The method of claim 1, wherein the duration is determined based on input received from the user.

3. The method of claim 1, wherein the duration is determined based on previous activities performed by the user.

4. The method of claim 1, wherein the duration is determined based on previous activities performed by the user at a certain time of day.

5. The method of claim 1, wherein the mood description of the activity is determined based on input received from the user.

6. The method of claim 1, wherein the mood description of the activity is determined based on-previous activities performed by the user.

7. The method of claim 1, wherein the mood description of the activity is determined based on-previous activities performed by the user at a certain time of day.

8. The method of claim 1, wherein the mood description of the activity is determined based on at least one of an environmental factor of an area around the user while performing the activity and at least one of motion data and biometric data of the user while performing the activity.

9. The method of claim 1, wherein automatically selecting entertainment content from the plurality of entertainment content to be presented during the activity comprises automatically selecting a plurality of pieces of entertainment content from the plurality of entertainment content.

10. The method of claim 1, further comprising sending information on at least two of the duration, the mood description, the entertainment content, and a description of the activity to social media.

11. A system for automatically identifying content to be presented to a user, the system comprising:
a storage device; and
processing circuitry configured to:
determine a duration during which a user will be performing an activity;
determine a mood description of the activity;
retrieve from the storage device, characteristics of a plurality of the entertainment content that include length of each of the plurality of entertainment content and a mood description of each of the plurality of entertainment content;
compare the retrieved characteristics with the duration of the activity and the mood description of the activity;
automatically select entertainment content from the plurality of entertainment content to be presented during the activity; and
cause the entertainment content to be presented to the user.

12. The system of claim 11, wherein the duration is determined based on input received from the user.

13. The system of claim 11, wherein the duration is determined based on previous activities performed by the user.

14. The system of claim 11, wherein the duration is determined based on previous activities performed by the user at a certain time of day.

15. The system of claim 11, wherein the mood description of the activity is determined based on input received from the user.

16. The system of claim 11, wherein the mood description of the activity is determined based on-previous activities performed by the user.

17. The system of claim 11, wherein the mood description of the activity is determined based on-previous activities performed by the user at a certain time of day.

18. The system of claim 11, wherein the mood description of the activity is determined based on at least one of an environmental factor of an area around the user while performing the activity and at least one of motion data and biometric data of the user while performing the activity.

19. The system of claim 11, wherein the processing circuitry is configured to automatically selecting entertainment content from the plurality of entertainment content to be presented during the activity by at least automatically selecting a plurality of pieces of entertainment content from the plurality of entertainment content.

20. The system of claim 11, wherein the processing circuitry is also configured to send information on at least two of the duration, the mood description, the entertainment content, and a description of the activity to social media.

21-30. (canceled)
